(19) United States
(12) Patent Application Publication
(10) Pub. No.: US 2024/0168398 A1
(43) Pub. Date: May 23, 2024

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: TATSUYA YAMAAI, Kanagawa (JP); NOBUHIRO NAKAMURA, Shizuoka (JP); TSUTOMU NISHIDA, Shizuoka (JP); DAISUKE MIURA, Tokyo (JP)

(21) Appl. No.: 18/489,936

(22) Filed: Oct. 19, 2023

(30) Foreign Application Priority Data
Nov. 1, 2022 (JP) 2022-175831

(51) Int. Cl. G03G 5/047; G03G 21/18

(52) U.S. Cl. CPC G03G 5/047; G03G 21/1814

(57) ABSTRACT

To provide an electrophotographic photosensitive member capable of satisfying both high durability and high sensitivity at a high level. An electrophotographic photosensitive member having a support, a charge generation layer formed on the support and a charge transport layer formed on the charge generation layer, the charge transport layer being a surface layer, in which the charge transport layer comprises a polyester resin having a structural unit represented by the following formula (1) and a charge-transporting compound represented by the following formula (HTM1).

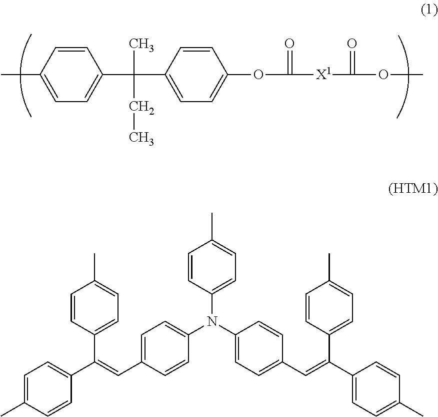

### BACKGROUND OF THE INVENTION

### Field of the Invention

The present invention relates to an electrophotographic photosensitive member, a process cartridge and an electrophotographic apparatus in which the electrophotographic photosensitive member is used.

### Description of the Related Art

As electrophotographic photosensitive members that are mounted in electrophotographic apparatuses or process cartridges, function separation multilayer photosensitive members having a charge generation layer containing a charge-generating substance and a charge transport layer containing a charge-transporting substance are ordinary.

In addition, recently, there has been an increasing demand for mass printing and printing speed improvement in electrophotographic processes, and, regarding charge transport layers, which often serve as the surface layers of electrophotographic photosensitive members, development intended to satisfy both an excellent mechanical strength and excellent electrical properties has been underway.

As binder resins for charge transport layers in electrophotographic photosensitive members, conventionally, polycarbonate resins have been frequently used; however, in Japanese Patent Application Laid-Open No. H10-039521, there has been a proposal of the use of a polyarylate resin having a higher mechanical strength than polycarbonate resins, which further improves the durability of electrophotographic photosensitive members. A polyarylate resin is one kind of aromatic dicarboxylic acid polyester resin. Furthermore, there has been another proposal of a photosensitive member having durability or electrical properties improved by containing a charge-transporting substance and a polyarylate resin disclosed in Japanese Patent Application Laid-Open No. 2007-72277 and Japanese Patent Application Laid-Open No. 2020-181012 in a photosensitive layer.

### SUMMARY OF THE INVENTION

As described above, regarding the extension of the service life and an increase in the speed of electrophotographic processes, which have been rapidly progressing recently, attempts are being made for a variety of improvements by using a polyarylate resin in charge transport layers in electrophotographic photosensitive members.

However, according to the present inventors' studies, it was found that, in association with an increase in the speed of electrophotographic processes, the use of a polyarylate resin in the charge transport layers creates a problem of the lack of sensitivity compared with a case where a polycarbonate resin is used.

Therefore, an objective of the present invention is to provide an electrophotographic photosensitive member satisfying both high durability and an increase in sensitivity at a high level, a process cartridge and an electrophotographic apparatus in which the electrophotographic photosensitive member is used.

The above-described objective is achieved by the present invention below.

More specifically, an electrophotographic photosensitive member according to the present invention is an electrophotographic photosensitive member having a support, a charge generation layer formed on the support and a charge transport layer formed on the charge generation layer and having the charge transport layer as a surface layer, characterized in that the charge transport layer comprises a polyester resin having a structural unit represented by the following formula (1) and a charge-transporting compound represented by the following formula (HTM1).

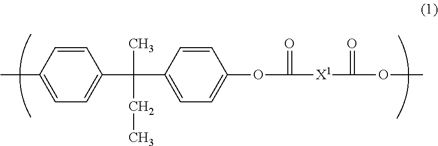

X¹ represents a divalent group represented by a formula (1A), a formula (1B), a formula (1C), a formula (1D) or a formula (1E).

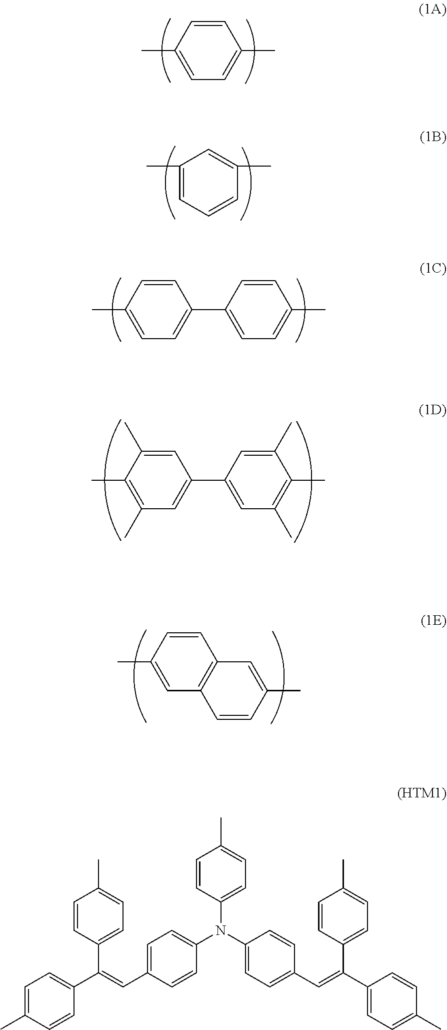

In addition, the present invention is a process cartridge that integrally supports the electrophotographic photosensitive member and at least one unit selected from the group consisting of a charging unit, a developing unit and a cleaning unit and that is attached detachably to a main body of an electrophotographic apparatus.

In addition, the present invention is an electrophotographic apparatus having the electrophotographic photosensitive member, a charging unit, an exposing unit, a developing unit and a transferring unit.

Further features of the present invention will become apparent from the following description of exemplary embodiments with reference to the attached drawings.

### BRIEF DESCRIPTION OF THE DRAWINGS

FIG. 1 is a view illustrating an example of the layer configuration of an electrophotographic photosensitive member relating to the present invention.

FIG. 2 is a view illustrating an example of the schematic configuration of an electrophotographic apparatus including a process cartridge having the electrophotographic photosensitive member relating to the present invention.

### DESCRIPTION OF THE EMBODIMENTS

Preferred embodiments of the present invention will now be described in detail in accordance with the accompanying drawings.

Hereinafter, the present invention will be described in detail with a preferable embodiment.

An electrophotographic photosensitive member of the present invention is an electrophotographic photosensitive member having a support, a charge generation layer formed on the support and a charge transport layer formed on the charge generation layer and having the charge transport layer as a surface layer, in which the charge transport layer comprises a polyester resin having a structural unit represented by the following formula (1) and a charge-transporting compound represented by the following formula (HTM1).

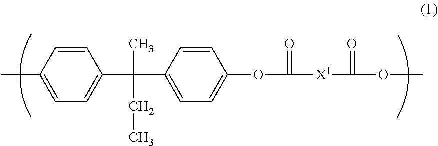

X¹ represents a divalent group represented by a formula (1A), a formula (1B), a formula (1C), a formula (1D) or a formula (1E).

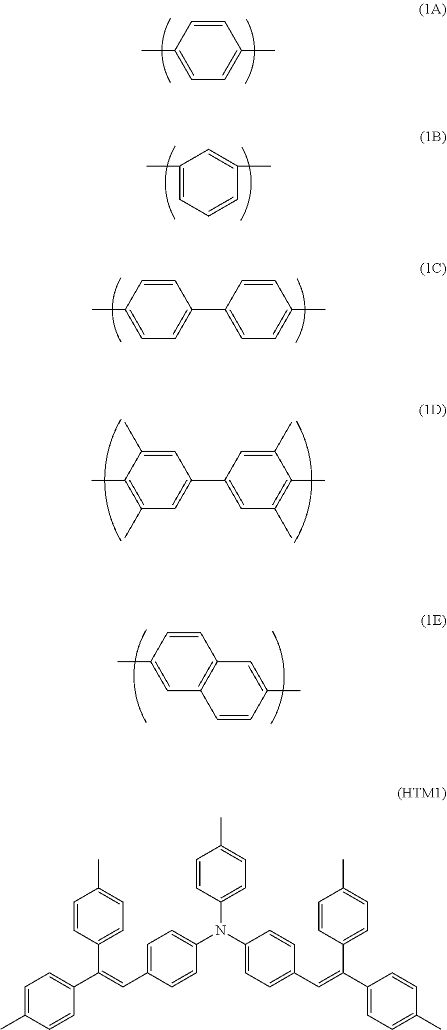

The present inventors presume a reason for the electrophotographic photosensitive member of the present invention to be capable of satisfying both high durability and a high sensitivity at a high level as described below.

When the polyester resin and the charge-transporting compound are present in the charge transport layer, an amine portion of the charge-transporting compound coordinates to an ester portion of the polyester resin. At this time, when the charge-transporting compound of the formula (HTM1) is used with respect to the polyester resin having a structural unit of the formula (1), the charge-transporting compound begins to coordinate to the polyester resin in a direction where steric hindrance is less likely to occur. As a result, the orientations of the molecules of the charge-transporting compound are aligned in the charge transport layer, which improves the hole-transporting properties. Therefore, the sensitivity significantly improves, and both high durability and a high sensitivity can be satisfied.

The content of the charge-transporting compound in the charge transport layer is preferably 60 mass % to 120 mass % with respect to the content of the polyester resin. When the content is in this range, both the wear resistance and sensitivity of the electrophotographic photosensitive member of the present invention can be satisfied at a higher level.

The polyester resin that is used in the charge transport layer of the electrophotographic photosensitive member of the present invention has the structural unit represented by the formula (1), and, while the content proportion thereof is arbitrary, the mass proportion of the structural unit represented by the formula (1) is preferably 50% to 100% with respect to all structural units in the polyester resin from the viewpoint of sensitivity improvement. The content proportion can be calculated from a 1H-NMR spectrum of the polyester resin obtained by measurement using a proton nuclear magnetic resonance spectrometer.

In addition, the polyester resin having the structural unit represented by the formula (1), which is used in the charge transport layer of the electrophotographic photosensitive member of the present invention, may have a different structural unit as long as the polyester resin has the structural unit represented by the formula (1) and may be a copolymer with a structural unit that is different from the formula (1) and contains a divalent carboxylic acid and a divalent organic residue.

The viscosity-average molecular weight of the polyester resin is preferably 10,000 to 80,000 and more preferably 40,000 to 70,000.

The content ratio (mass ratio) between the charge-transporting compound represented by the formula (HTM1) and the polyester resin having the structural unit represented by the formula (1) in the charge transport layer is preferably 4:10 to 20:10 and more preferably 6:10 to 12:10.

In addition, when the charge transport layer of the present invention contains a silica particle as a filler particle, the durability (hereinafter, also referred to as “wear resistance”) can be improved without causing the degradation of the sensitivity. The number-average primary particle diameter of the filler particles is preferably 5 nm to 1000 nm. In order to improve the wear resistance of the electrophotographic photosensitive member, the number-average primary particle diameter of the filler particles is more preferably 10 nm to 150 nm.

[Electrophotographic Photosensitive Member]

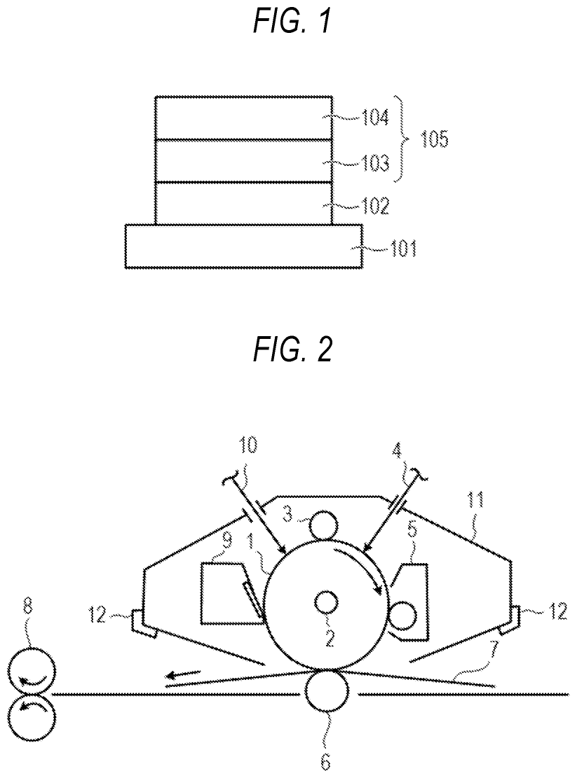

The electrophotographic photosensitive member of the present invention has a support and a photosensitive layer formed on the support. FIG. 1 is a view illustrating an example of the layer configuration of the electrophotographic photosensitive member. In FIG. 1, 101 is the support, 102 is an undercoat layer, 103 is the charge generation layer, 104 is the charge transport layer, and 105 is the photosensitive layer (multilayer photosensitive layer).

<Support>

In the present invention, the support is preferably a conductive support having conductivity. Examples of the conductive support include supports formed of a metal such as aluminum, iron, nickel, copper or gold or an alloy thereof or supports having a thin film of a metal such as aluminum, chromium, silver or gold; a thin film of a conductive material such as indium oxide, tin oxide or zinc oxide; a thin film of a conductive ink to which silver nanowires have been added formed on an insulating support of a polyester resin, a polycarbonate resin, a polyimide resin, glass or the like.

On the surfaces of the support, an electrochemical treatment such as anodization, wet honing, blasting, machining or the like may be performed to improve the electrical properties or suppress interference fringes. Examples of the shape of the support include a cylindrical shape and a film shape.

<Conductive Layer>

In the present invention, a conductive layer may be provided on the support. When the conductive layer is provided, unevenness or defects on the support can be coated, and interference fringes can be prevented. The average film thickness of the conductive layer is preferably 5 μm to 40 μm.

The conductive layer preferably contains a conductive particle and a binder resin. Examples of the conductive particle include carbon black, a metal particle and a metal oxide particle. Examples of the metal oxide include zinc oxide, aluminum oxide, indium oxide, silicon oxide, zirconium oxide, tin oxide, titanium oxide, magnesium oxide, antimony oxide and bismuth oxide. Examples of the metal include aluminum, nickel, iron, chromium, copper, zinc and silver.

Among these, as the conductive particle, the metal oxide is preferably used, and, particularly, titanium oxide, tin oxide and zinc oxide are more preferably used.

In a case where the metal oxide is used as the conductive particle, the surface of the metal oxide may be treated with a silane coupling agent or the like or an element such as phosphorus or aluminum or an oxide thereof may be doped into the metal oxide. Examples of the element or the oxide thereof to be doped include phosphorus, aluminum, niobium and tantalum.

In addition, the conductive particle may be provided with a multilayer configuration having a core particle and a coating layer that coats the particle. Examples of the core particle include titanium oxide, barium sulfate and zinc oxide. Examples of the coating layer include metal oxides such as tin oxide and titanium oxide.

In addition, in a case where the metal oxide is used as the conductive particle, the volume-average particle diameter thereof is preferably 1 nm to 500 nm.

Examples of the resin include a polyester resin, a polycarbonate resin, a polyvinyl acetal resin, an acrylic resin, a silicone resin, an epoxy resin, a melamine resin, a polyurethane resin, a phenolic resin and an alkyd resin.

In addition, the conductive layer may further contain a masking agent such as silicone oil, a resin particle or titanium oxide or the like.

The average film thickness of the conductive layer is preferably 1 μm to 50 μm.

The conductive layer can be formed by preparing a coating solution for the conductive layer containing each of the above-described materials and a solvent and forming and drying a coating film thereof. Examples of the solvent that is used in the coating solution include an alcoholic solvent, a sulfoxide solvent, a ketone solvent, an ether solvent, an ester solvent and an aromatic hydrocarbon solvent. Examples of a dispersion method for dispersing the conductive particle in the coating solution for the conductive layer include methods in which a paint shaker, a sand mill, a ball mill or a liquid collision-type high speed disperser is used.

<Undercoat Layer>

An undercoat layer may be provided between the support and the charge generation layer. The undercoat layer contains a polyamide resin and a titanium oxide particle. As the polyamide resin, a polyamide resin that is soluble in alcoholic solvents is preferable. For example, a ternary (6-66-610) copolyamide, a quaternary (6-66-610-12) copolyamide, N-methoxymethylated nylon, a dimer fatty acid-based polyamide, a dimer fatty acid-based polyamide block copolymer, a copolyamide having a diamine component or the like is preferably used.

As the titanium oxide particle, a titanium oxide particle having a rutile-type or anatase-type crystal structure is preferable from the viewpoint of suppressing charge accumulation. The average primary particle diameter of the titanium oxide particles is preferably 10 nm to 100 nm. The titanium oxide particle may be treated with a silane coupling agent or the like.

The undercoat layer in the present invention may contain, aside from the polyamide resin or the titanium oxide particle, an additive such as an organic substance particle or a leveling agent for the purpose of enhancing the film formation properties of the undercoat layer in the electrophotographic photosensitive member.

The average film thickness of the undercoat layer is preferably 0.5 μm to 5 μm. The undercoat layer can be formed by preparing a coating solution for the undercoat layer containing each of the above-described materials and a solvent and forming, drying and/or curing a coating film thereof. Examples of the solvent that is used in the coating solution include an alcoholic solvent, a ketone solvent, an ether solvent, an ester solvent and an aromatic hydrocarbon solvent. Examples of a dispersion method for dispersing the titanium oxide particle in the coating solution for the undercoat layer include methods in which ultrasonic dispersion, a paint shaker, a sand mill, a ball mill or a liquid collision-type high speed disperser is used.

<Charge Generation Layer>

The charge generation layer preferably contains a charge-generating substance and a resin.

As the charge-generating substance that is used in the charge generation layer, a phthalocyanine pigment is preferable. Examples of phthalocyanine include titanyl phthalocyanine, hydroxygallium phthalocyanine and chlorogallium phthalocyanine, and, among these, titanyl phthalocyanine is more preferable.

Examples of the binder resin that is used in the charge generation layer include resins (insulating resins) such as a polyvinyl butyral resin, a polyvinyl acetal resin, a polyarylate resin, a polycarbonate resin, a polyester resin, a polyvinyl acetate resin, a polysulfone resin, a polystyrene resin, a phenoxy resin, an acrylic resin, a polyacrylamide resin, a polyvinylpyridine resin, an urethane resin, an agarose resin, a cellulose resin, a casein resin, a polyvinyl alcohol resin, a polyvinylpyrrolidone resin, a vinylidene chloride resin, an acrylonitrile copolymer and a polyvinylbenzal resin. In addition, an organic photoconductive polymer such as poly-N-vinylcarbazole, polyvinylanthracene or polyvinylpyrene can be used. In addition, only one binder resin may be used, or two or more binder resins may be used as a mixture or a copolymer.

Examples of a solvent that is used in a coating solution for the charge generation layer include toluene, xylene, tetralin, chlorobenzene, dichloromethane, chloroform, trichloroethylene, tetrachloroethylene, carbon tetrachloride, methyl acetate, ethyl acetate, propyl acetate, methyl formate, ethyl formate, acetone, methyl ethyl ketone, cyclohexanone, diethyl ether, dipropyl ether, propylene glycol monomethyl ether, dioxane, methylal, tetrahydrofuran, water, methanol, ethanol, n-propanol, isopropanol, butanol, methyl cellosolve, methoxypropanol, dimethylformamide, dimethylacetamide and dimethylsulfoxide. In addition, the solvent can be used singly, or in combination of two or more solvents.

The charge generation layer can be obtained by dispersing a phthalocyanine pigment as the charge-generating substance and the binder resin as necessary in the solvent to prepare the coating solution for the charge generation layer and forming and drying a coating film of the coating solution for the charge generation layer.

The coating solution for the charge generation layer may be prepared by adding only the charge-generating substance to the solvent, performing a dispersion treatment thereon and then adding the binder resin thereto or may be prepared by adding the charge-generating substance and the binder resin together to the solvent and performing a dispersion treatment.

At the time of the dispersion, a disperser such as a media-type disperser such as a sand mill or a ball mill, a liquid collision-type disperser or an ultrasonic disperser can be used.

<Charge Transport Layer>

In the electrophotographic photosensitive member of the present invention, the surface layer is the charge transport layer. The charge transport layer has the above-described polyester resin and charge-transporting compound.

The charge transport layer may contain an additive such as an antioxidant, an ultraviolet absorber, a plasticizer, a leveling agent, a lubrication agent or a wear resistance improver. Specific examples thereof include a hindered phenol compound, a hindered amine compound, a sulfur-containing compound, a phosphorus-containing compound, a benzophenone compound, a siloxane-modified resin, silicone oil, a fluororesin particle, a polystyrene resin particle, a polyethylene resin particle, a silica particle, an alumina particle and a boron nitride particle.

The average film thickness of the charge transport layer is preferably 5 μm to 50 μm and more preferably 8 μm to 40 μm.

The charge transport layer can be formed by preparing a coating solution for the charge transport layer containing each of the above-described materials and a solvent and forming and drying a coating film thereof. Examples of the solvent that is used in the coating solution include an alcoholic solvent, a ketone solvent, an ether solvent, an ester solvent and an aromatic hydrocarbon solvent. Among these solvents, the ether solvent or the aromatic hydrocarbon solvent is preferable.

<Process Cartridge and Electrophotographic Apparatus>

FIG. 2 illustrates an example of the schematic configuration of an electrophotographic apparatus having a process cartridge including the electrophotographic photosensitive member. In FIG. 2, 1 is a cylindrical (drum-like) electrophotographic photosensitive member and is driven to rotate around a shaft 2 in an arrow direction at a predetermined frequency (process speed).

The surface of the electrophotographic photosensitive member 1 is charged to a predetermined positive or negative potential with a charging unit 3 in a rotation process. Then, the charged surface of the electrophotographic photosensitive member 1 is irradiated with exposure light 4 from an exposing unit (not illustrated), and an electrostatic latent image corresponding to target image information is formed. The exposure light 4 is, for example, a light that is output from an exposing unit such as slit exposure or laser beam scanning exposure and has an intensity modulated in response to the time-order electrical digital image signal of target image information.

The electrostatic latent image formed on the surface of the electrophotographic photosensitive member 1 is developed (normal development or reversal development) with toner accommodated in a developing unit 5, and a toner image is formed on the surface of the electrophotographic photosensitive member 1. The toner image formed on the surface of the electrophotographic photosensitive member 1 is transferred to a transfer material 7 with a transferring unit 6. At this time, to the transferring unit 6, a bias voltage having a reverse polarity with respect to charges in the toner is applied from a bias power supply (not illustrated). In addition, in a case where the transfer material 7 is paper, the transfer material 7 is taken out from a paper feed portion (not illustrated) and fed into a space between the electrophotographic photosensitive member 1 and the transferring unit 6 in synchronization with the rotation of the electrophotographic photosensitive member 1.

The transfer material 7 to which the toner image has been transferred from the electrophotographic photosensitive member 1 is separated from the surface of the electrophotographic photosensitive member 1, then, conveyed to a fixing unit 8, subjected to a fixing treatment of the toner image and thereby printed out outside of the electrophotographic apparatus as an image-formed article (print or copy). After the transfer of the toner image to the transfer material 7, the surface of the electrophotographic photosensitive member 1 is cleaned by removing a deposit such as the toner (residual toner after the transfer) with a cleaning unit 9. A cleaner-less system, which has been developed recently, enables the direct removal of the residual toner after the transfer with a developer or the like. Furthermore, the surface of the electrophotographic photosensitive member 1 is neutralized with front exposure light 10 from a front exposing unit (not illustrated) and then repeatedly used for image formation. In a case where the charging unit 3 is a contact charging unit in which a charging roller or the like is used, the front exposing unit is not necessarily required. In the present invention, among the above-described configuration elements such as the electrophotographic photosensitive member 1, the charging unit 3, the developing unit 5 and the cleaning unit 9, a plurality of configuration elements is put into a container and integrally supported to form a process cartridge. This process cartridge can be configured to be attached detachably to the main bodies of electrophotographic apparatus. For example, at least one selected from the charging unit 3, the developing unit 5 and the cleaning unit 9 is integrally supported with the electrophotographic photosensitive member 1 to form a process cartridge. A process cartridge 11 can be configured to be attached detachably to the main bodies of electrophotographic apparatus using a guiding unit 12 such as a rail for the main bodies of electrophotographic apparatus. The exposure light 4 may be reflected light or transmitted light from a manuscript in a case where an electrophotographic apparatus is a copier or a printer. Alternatively, the exposure light may be light that is radiated by the scanning of laser beams, the driving of an LED array, the driving of a liquid crystal shutter array or the like that is performed according to signals produced by scanning a manuscript with a sensor.

The electrophotographic photosensitive member 1 of the present invention can also be widely applied in the electrophotographic application fields such as laser beam printers, CRT printers, LET printers, FAXs, liquid crystal printers and laser plate making.

<Materials Used in Examples and Comparative Examples>

As materials for producing photosensitive members, the following charge-generating substances, charge-transporting compounds, binder resins and filler resins were prepared.

[Charge-Generating Substance]

As crystals of titanyl phthalocyanine, Y-type titanyl phthalocyanine (CGM1) having a strong peak at a Bragg angle 2θ±0.2° of 27.2° in CuKα characteristic X-ray diffraction and crystal-form hydroxygallium phthalocyanine (CGM2) having strong peaks at Bragg angles 2θ±0.2° of 7.4° and 28.1° in CuKα characteristic X-ray diffraction were prepared.

[Charge-Transporting Compound]

The above-described charge-transporting compound (HTM1) was prepared. Furthermore, charge-transporting compounds (HTM2) to (HTM6) were prepared.

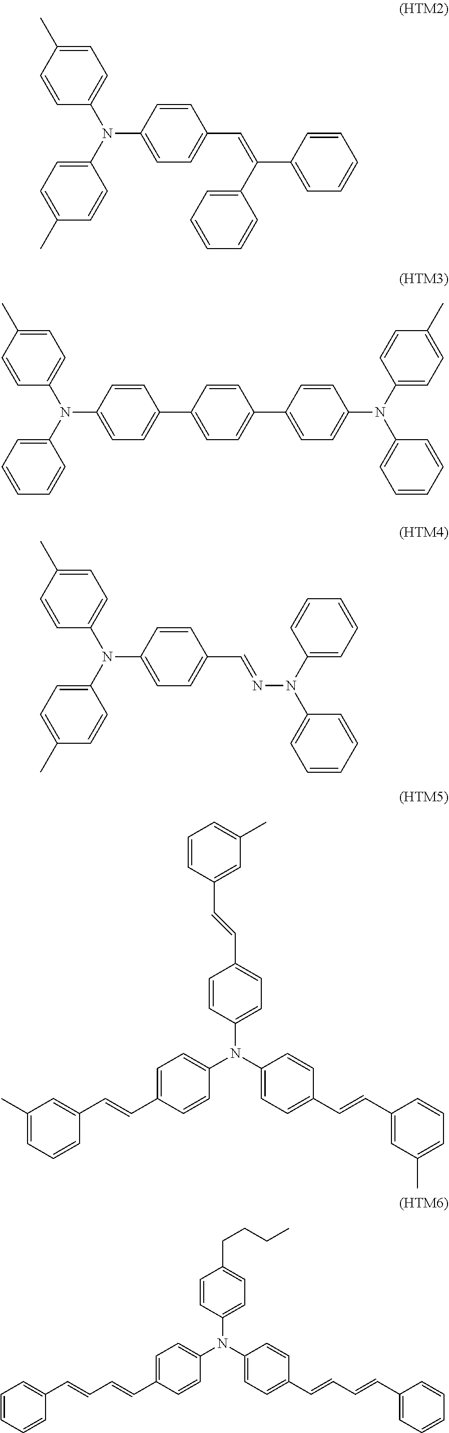

[Binder Resin]

The polyester resin that is used in the present invention may be synthesized by an ester exchange method between a dicarboxylic acid ester and a compound having a hydroxyl group or may be synthesized by a polymerization method between a divalent acid halide such as dicarboxylic acid halide and a compound having a hydroxyl group such as bisphenol and is preferably synthesized by the latter synthesis method from the viewpoint of the properties of controlling the molecular weight of a product to be obtained.

(Polyester Resin (1-1))

Hereinafter, a method for synthesizing a polyester resin represented by the following formula (1-1) will be described as a synthesis example.

Dicarboxylic acid chloride having a structure represented by the following formula (DC-1) was dissolved in dichloromethane to prepare an acid chloride solution.

In addition, separately from this acid chloride solution, bisphenol having a structure represented by the following formula (BP-1) was dissolved in 10% sodium hydroxide aqueous solution, and tributylbenzylammonium chloride was added to this solution as a polymerization catalyst and stirred, thereby preparing a bisphenol solution.

Next, the acid chloride solution was added to the bisphenol solution while being stirred to start polymerization. The polymerization was performed for three hours under stirring with the reaction temperature held at 25° C.

After that, acetic acid was added thereto to stop the polymerization reaction, and a reaction product was repeatedly washed in water until a water layer became neutral.

After the washing, the reaction product was added dropwise to methanol under stirring, a polymer was precipitated, and this polymer was dried in a vacuum, thereby obtaining a polyarylate resin represented by the formula (1-1). The viscosity-average molecular weight of the obtained polyarylate resin represented by the formula (1-1) was 46,500.

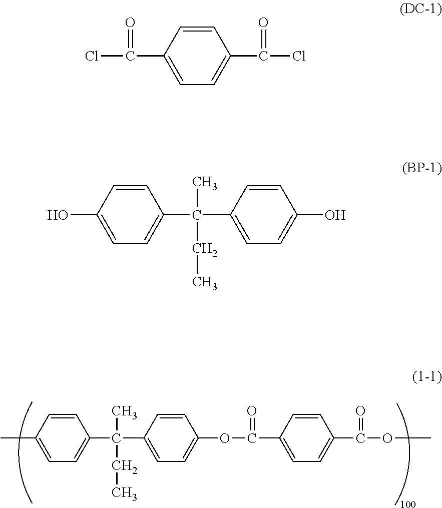

(Polyester Resins (1-2) to (1-24))

Hereinafter, the structures of polyester resins used in the present invention will be shown. In addition, the viscosity-average molecular weights of the polyester resins are shown in Table 1.

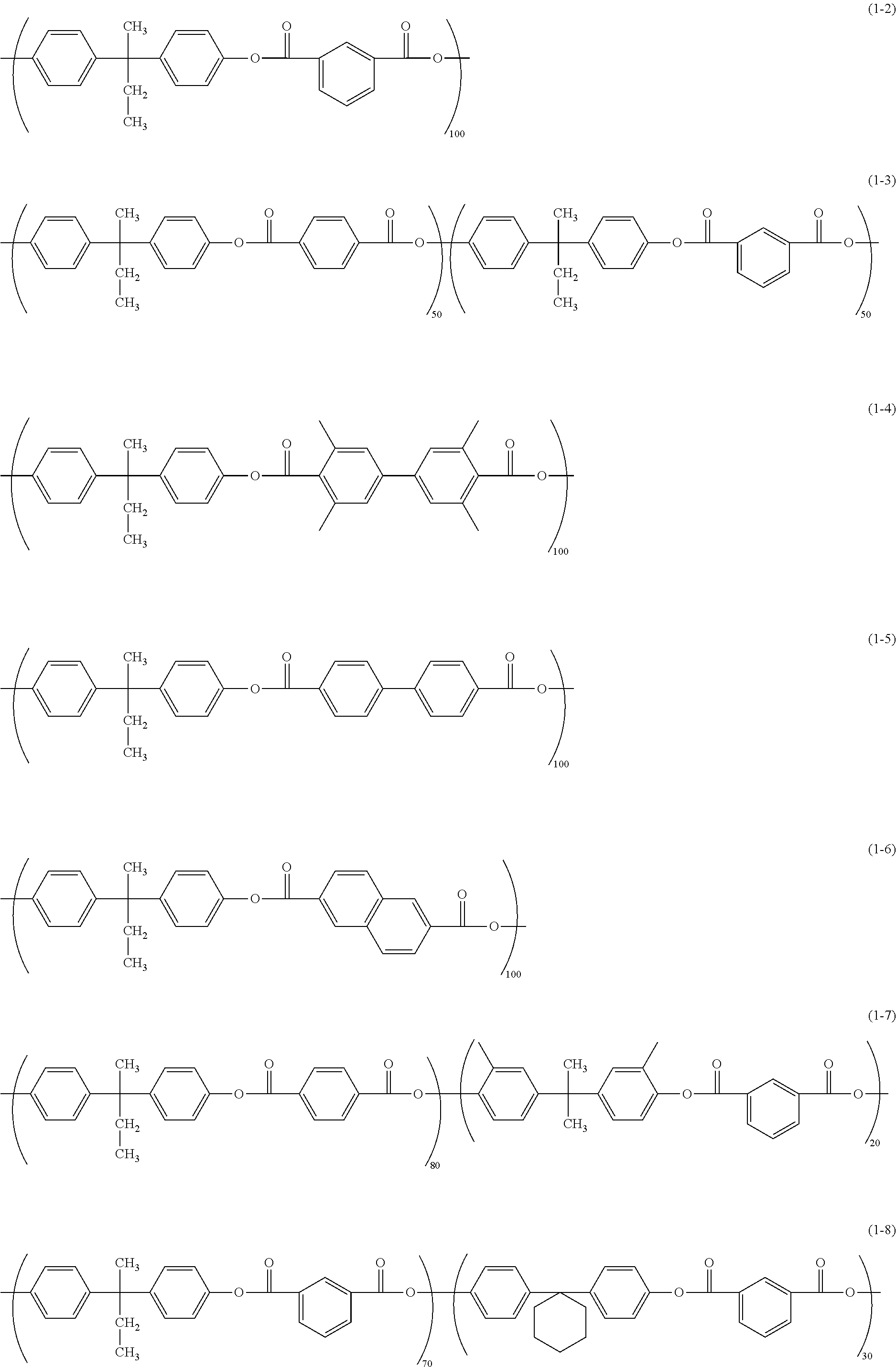

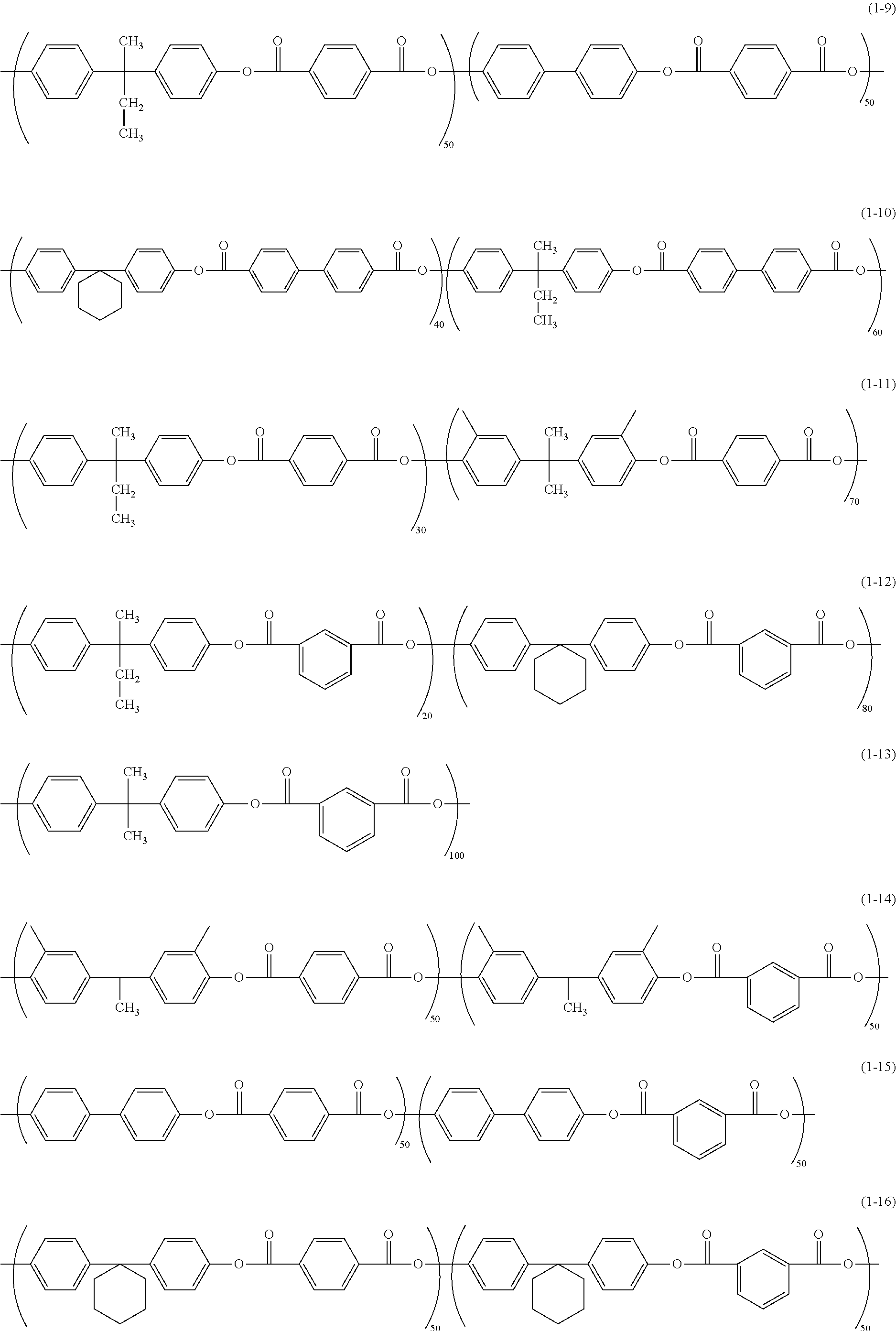

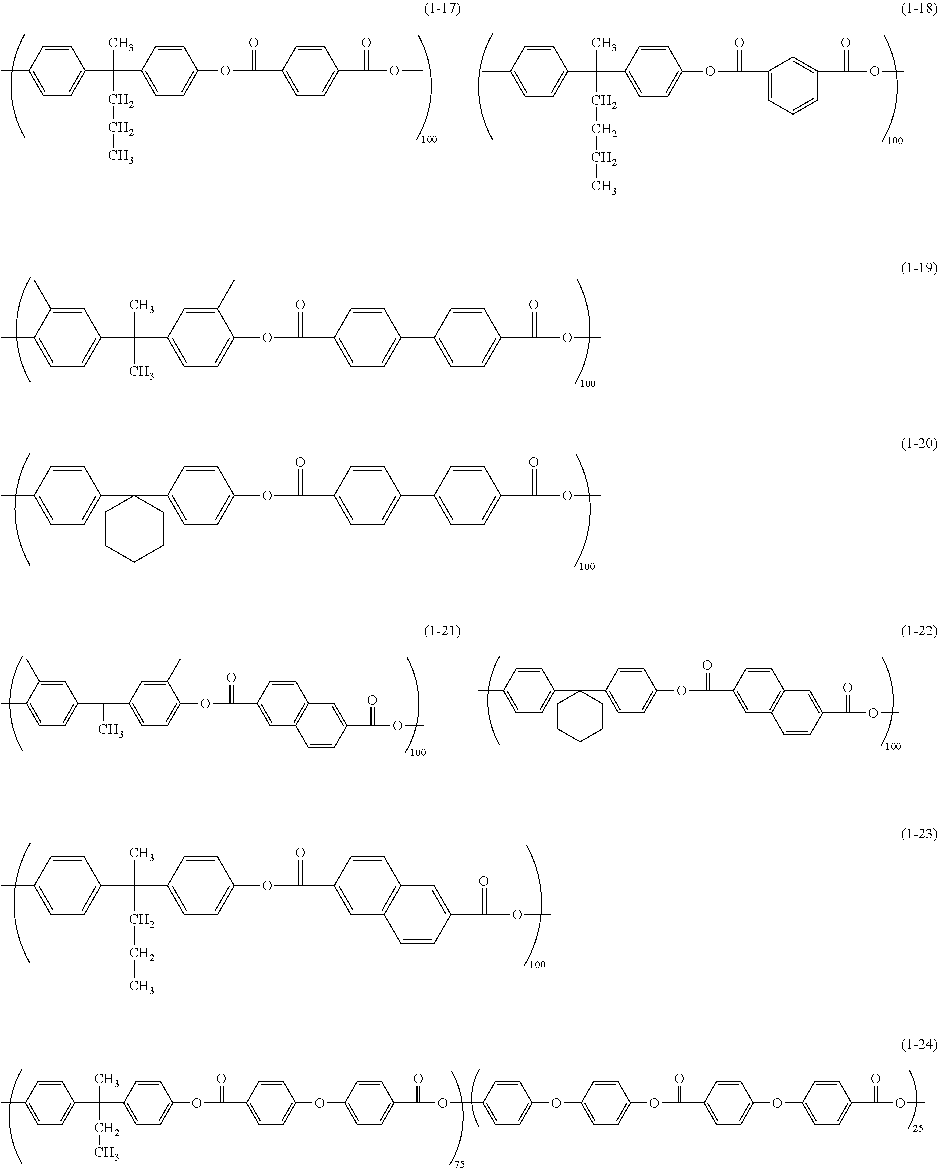

TABLE 1

| | Viscosity-average |
|---|---|
| Polyester resin | molecular weight |
| (1-1) | 46500 |
| (1-2) | 45200 |
| (1-3) | 43600 |
| (1-4) | 47400 |
| (1-5) | 42500 |
| (1-6) | 45600 |
| (1-7) | 45200 |
| (1-8) | 41800 |
| (1-9) | 43200 |
| (1-10) | 41000 |
| (1-11) | 47700 |
| (1-12) | 38600 |
| (1-13) | 42200 |
| (1-14) | 49100 |
| (1-15) | 46200 |
| (1-16) | 41500 |
| (1-17) | 43700 |
| (1-18) | 42000 |
| (1-19) | 45900 |
| (1-20) | 44800 |
| (1-21) | 40900 |
| (1-22) | 46000 |
| (1-23) | 48100 |
| (1-24) | 42200 |

(Polycarbonate Resin (2-1))

The following polycarbonate resin was prepared.

“LUPILON Z400” (viscosity-average molecular weight 40,000) manufactured by Mitsubishi Gas Chemical Company, Inc.

[Filler Particle]

Filler particles (Filler Particle 1) to (Filler Particle 3) to be described below were prepared. AEROSIL is a registered trademark. Each filler particle was surface-treated with HDMS hexamethylsilazane.

(Filler Particle 1)

“AEROSIL (registered trademark) RX300” manufactured by Nippon Aerosil Co., Ltd.

Number-average primary particle diameter: 7 nm

(Filler Particle 2)

“AEROSIL (registered trademark) RX200” manufactured by Nippon Aerosil Co., Ltd.

Number-average primary particle diameter: 12 nm

(Filler Particle 3)

“AEROSIL (registered trademark) RX50” manufactured by Nippon Aerosil Co., Ltd.

Number-average primary particle diameter: 40 nm

According to the present invention, an electrophotographic photosensitive member capable of satisfying both high durability and a high sensitivity, which are required for electrophotographic photosensitive members, at a high level, a process cartridge and an electrophotographic apparatus in which the electrophotographic photosensitive member is used can be provided.

### EXAMPLES

Hereinafter, the present invention will be described in more detail using examples and comparative examples. The present invention is not limited to the following examples within the scope of the gist.

The film thickness of each layer of electrophotographic photosensitive members of the examples and the comparative examples was, except a charge generation layer, obtained by a method in which an eddy-current film thickness meter (Fischerscope, manufactured by Fischer Instruments K.K.) was used or a method in which the mass per unit area was converted to the specific gravity. The film thickness of the charge generation layer was measured by converting a Macbeth concentration value of the photosensitive member using the Macbeth concentration value measured by pressing a spectrodensitometer (trade name: X-Rite 504/508, manufactured by X-Rite, Incorporated) against the surface of the photosensitive member and a calibration curve acquired in advance from a film thickness value measured by the observation of a cross-sectional SEM image.

### Example 1

<Undercoat Layer>

Surface-treated titanium oxide (number-average primary particle diameter: 10 nm) was prepared. The titanium oxide was surface-treated using alumina and silica, and the surface-treated titanium oxide was further surface-treated using methylhydrogen polysiloxane while being wet-dispersed. Next, 2 parts by mass of the surface-treated titanium oxide, 1 part by mass of a polyamide resin (“AMILAN CM8000” manufactured by Toray Industries, Inc., a quaternary copolyamide resin from polyamide 6, polyamide 12, polyamide 66 and polyamide 610), 10 parts by mass of methanol, 1 part by mass of butanol and 1 part by mass of toluene were mixed together using a bead mill for five hours, thereby obtaining a coating solution for an undercoat layer. After that, a conductive support was dip-coated using the obtained coating solution for an undercoat layer to form a coating film, and the coating film was heated and dried at 130° C. for 30 minutes, thereby forming an undercoat layer having a film thickness of 1.5 μm. As the conductive support, a cylindrical aluminum support was used.

<Charge Generation Layer>

Y-type titanyl phthalocyanine (CGM1) (1.5 parts by mass) as a charge-generating substance and a polyvinyl acetal resin (“S-LEC B BX-5” manufactured by Sekisui Chemical Co., Ltd.) (1 part by mass) were added to a solvent containing propylene glycol monomethyl ether (40 parts by mass) and tetrahydrofuran (40 parts by mass). Using a bead mill, these materials and the solvent were mixed for 12 hours, and the materials were dispersed in the solvent, thereby producing a coating solution for a charge generation layer. The undercoat layer was dip-coated with the obtained coating solution for a charge generation layer to form a coating film, and the coating film was heated and dried at a temperature of 100° C. for 10 minutes, thereby forming a charge generation layer having a film thickness of 0.25 μm.

<Charge Transport Layer>

Ten parts by mass of (HTM1) as a charge-transporting compound, 10 parts by mass of the polyester resin (1-1) as a binder resin and a solvent containing 150 parts by mass of tetrahydrofuran and 50 parts by mass of toluene were mixed to produce a coating solution for a charge transport layer. The charge generation layer was dip-coated with the obtained coating solution for a charge transport layer to form a coating film, and the coating film was heated and dried at a temperature of 120° C. for 30 minutes, thereby forming a charge transport layer having a film thickness of 30 μm.

### Examples 2 to 20 and Comparative Examples 1 to 24

The kind of the charge-generating substance in the charge generation layer, the kind of the charge-transporting compound in the charge transport layer, the kind of the binder resin, the kind of the filler particle and the content of the charge-transporting compound with respect to the content of the binder resin were each changed from [Example 1] so as to be as shown in Table 2 below, thereby producing electrophotographic photosensitive members. In addition, the electrophotographic photosensitive members were produced so that the content of the filler in the charge transport layer reached a mass proportion of 5% with respect to the total mass of the binder resin.

<Evaluation>

The following evaluations were performed using the electrophotographic photosensitive members produced above. The evaluation results are shown in Table 2.

[Evaluation of Wear Resistance]

An evaluation machine used for the evaluation of the wear resistance was a color copier (“X4300LX” manufactured by Samsung). Ten thousand images were output using the evaluation machine under an environment of a temperature of 15° C. and a relative humidity of 10% RH, and the amounts of the charge transport layer worn were obtained from the differences between the photosensitive member film thicknesses before and after the repeated image output.

[Evaluation of Electrical Properties]

The initial sensitivity of the photosensitive member was evaluated by the next method. The surface of the photosensitive member was charged to −600 V using a drum sensitivity tester (manufactured by GENTEC) under an environment of a temperature of 25° C. and a relative humidity of 50% RH. Next, monochromatic light (wavelength: 780 nm, the amount of light on the surface of the electrophotographic photosensitive member: 0.35 μJ/cm 2) was extracted from the white light of a halogen lamp using a band pass filter, and the surface of the photosensitive member was irradiated with the monochromatic light. The surface potential of the photosensitive member was measured when 50 milliseconds elapsed from the start of the irradiation.

TABLE 2

| | Charge | Charge transport layer | | | | | |
|---|---|---|---|---|---|---|---|
| | generation | | | Mass % ratio | | | |
| | layer | | | of charge- | | Evaluation result | |
| | Charge- | | Charge- | transporting | | Wear | Initial |
| | generating | Binder | transporting | compound/ | Filler | resistance | sensitivity |
| | substance | resin | compound | binder resin | particle | (μm/k) | (V) |
| Example 1 | CGM1 | (1-1) | HTM1 | 10/10 | None | 0.2 | −82 |
| Example 2 | CGM1 | (1-2) | HTM1 | 10/10 | None | 0.22 | −82 |
| Example 3 | CGM1 | (1-3) | HTM1 | 10/10 | None | 0.21 | −75 |
| Example 4 | CGM1 | (1-4) | HTM1 | 10/10 | None | 0.19 | −86 |
| Example 5 | CGM1 | (1-5) | HTM1 | 10/10 | None | 0.18 | −87 |
| Example 6 | CGM1 | (1-6) | HTM1 | 10/10 | None | 0.24 | −90 |
| Example 7 | CGM1 | (1-7) | HTM1 | 10/10 | None | 0.22 | −82 |
| Example 8 | CGM1 | (1-8) | HTM1 | 10/10 | None | 0.22 | −85 |
| Example 9 | CGM1 | (1-9) | HTM1 | 10/10 | None | 0.22 | −90 |
| Example 10 | CGM1 | (1-10) | HTM1 | 10/10 | None | 0.18 | −90 |
| Example 11 | CGM1 | (1-11) | HTM1 | 10/10 | None | 0.22 | −94 |
| Example 12 | CGM1 | (1-12) | HTM1 | 10/10 | None | 0.23 | −95 |
| Example 13 | CGM1 | (1-1) | HTM1 | 12/10 | None | 0.23 | −75 |
| Example 14 | CGM1 | (1-1) | HTM1 | 14/10 | None | 0.26 | −70 |
| Example 15 | CGM1 | (1-7) | HTM1 | 6/10 | None | 0.17 | −87 |
| Example 16 | CGM1 | (1-7) | HTM1 | 4/10 | None | 0.15 | −96 |
| Example 17 | CGM2 | (1-7) | HTM1 | 10/10 | None | 0.2 | −90 |
| Example 18 | CGM1 | (1-3) | HTM1 | 10/10 | Filler 1 | 0.2 | −76 |
| Example 19 | CGM1 | (1-3) | HTM1 | 10/10 | Filler 2 | 0.17 | −77 |
| Example 20 | CGM1 | (1-3) | HTM1 | 10/10 | Filler 3 | 0.18 | −76 |
| Comparative | CGM1 | (1-13) | HTM1 | 10/10 | None | 0.21 | −110 |
| Example 1 | | | | | | | |
| Comparative | CGM1 | (1-14) | HTM1 | 10/10 | None | 0.22 | −113 |
| Example 2 | | | | | | | |
| Comparative | CGM1 | (1-15) | HTM1 | 10/10 | None | 0.19 | −115 |
| Example 3 | | | | | | | |
| Comparative | CGM1 | (1-16) | HTM1 | 10/10 | None | 0.23 | −111 |
| Example 4 | | | | | | | |
| Comparative | CGM1 | (1-17) | HTM1 | 10/10 | None | 0.24 | −112 |
| Example 5 | | | | | | | |
| Comparative | CGM1 | (1-18) | HTM1 | 10/10 | None | 0.25 | −114 |
| Example 6 | | | | | | | |
| Comparative | CGM1 | (1-19) | HTM1 | 10/10 | None | 0.18 | −116 |
| Example 7 | | | | | | | |
| Comparative | CGM1 | (1-20) | HTM1 | 10/10 | None | 0.19 | −114 |
| Example 8 | | | | | | | |
| Comparative | CGM1 | (1-21) | HTM1 | 10/10 | None | 0.25 | −110 |
| Example 9 | | | | | | | |
| Comparative | CGM1 | (1-22) | HTM1 | 10/10 | None | 0.26 | −110 |
| Example 10 | | | | | | | |
| Comparative | CGM1 | (1-23) | HTM1 | 10/10 | None | 0.25 | −115 |
| Example 11 | | | | | | | |
| Comparative | CGM1 | (1-24) | HTM1 | 10/10 | None | 0.24 | −108 |
| Example 12 | | | | | | | |
| Comparative | CGM1 | (1-13) | HTM1 | 10/10 | Filler 1 | 0.19 | −125 |
| Example 13 | | | | | | | |
| Comparative | CGM1 | (1-13) | HTM1 | 10/10 | Filler 2 | 0.18 | −122 |
| Example 14 | | | | | | | |
| Comparative | CGM1 | (1-13) | HTM1 | 10/10 | Filler 3 | 0.18 | −125 |
| Example 15 | | | | | | | |
| Comparative | CGM1 | (1-1) | HTM2 | 10/10 | None | 0.2 | −120 |
| Example 16 | | | | | | | |
| Comparative | CGM1 | (1-1) | HTM3 | 10/10 | None | 0.21 | −115 |
| Example 17 | | | | | | | |
| Comparative | CGM1 | (1-1) | HTM4 | 10/10 | None | 0.2 | −116 |
| Example 18 | | | | | | | |
| Comparative | CGM1 | (1-5) | HTM5 | 10/10 | None | 0.18 | −120 |
| Example 19 | | | | | | | |
| Comparative | CGM1 | (1-6) | HTM6 | 10/10 | None | 0.23 | −111 |
| Example 20 | | | | | | | |
| Comparative | CGM1 | (1-14) | HTM2 | 10/10 | None | 0.21 | −118 |
| Example 21 | | | | | | | |
| Comparative | CGM1 | (1-22) | HTM2 | 10/10 | None | 0.25 | −111 |
| Example 22 | | | | | | | |
| Comparative | CGM1 | (1-24) | HTM2 | 10/10 | None | 0.25 | −109 |
| Example 23 | | | | | | | |
| Comparative | CGM1 | (2-1) | HTM1 | 10/10 | None | 0.41 | −96 |
| Example 24 | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-175831, filed Nov. 1, 2022, which is hereby incorporated by reference herein in its entirety.

What is claimed is:

1. An electrophotographic photosensitive member comprising:
a support;
a charge generation layer formed on the support; and
a charge transport layer formed on the charge generation layer, where the charge transport layer being a surface layer,
wherein the charge transport layer comprises
a polyester resin having a structural unit represented by the following formula (1), where X¹ represents a divalent group represented by a formula (1A), a formula (1B), a formula (1C), a formula (1D) or a formula (1E), and
a charge-transporting compound represented by the following formula (HTM1);

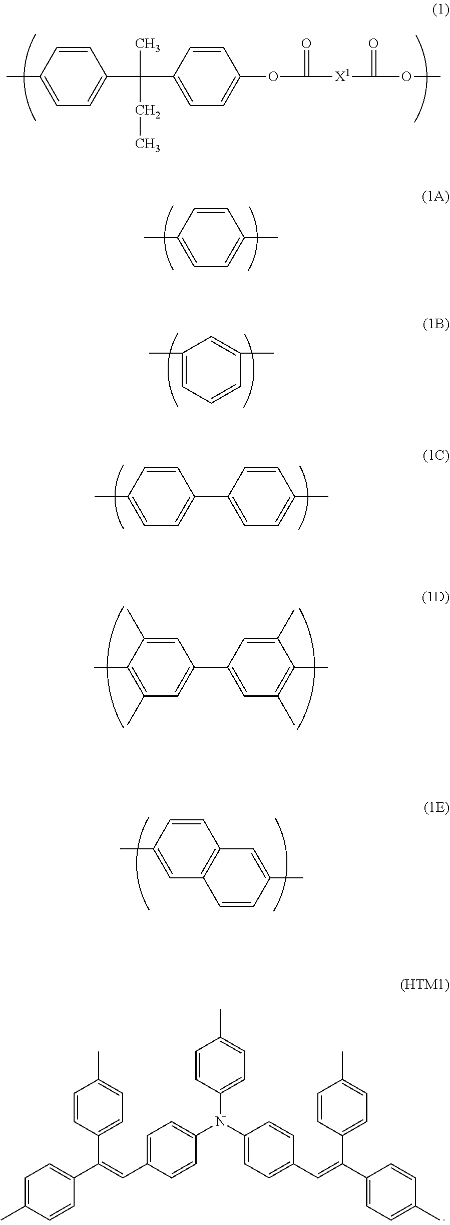

2. The electrophotographic photosensitive member according to claim 1,
wherein a content of the charge-transporting compound in the charge transport layer is 60 mass % to 120 mass % with respect to a content of the polyester resin.

3. The electrophotographic photosensitive member according to claim 1,
a mass proportion of the structural unit represented by the formula (1) is 50% to 100% with respect to all structural units in the polyester resin.

4. The electrophotographic photosensitive member according to claim 1,
wherein the charge-generating substance in the charge generation layer is titanyl phthalocyanine.

5. The electrophotographic photosensitive member according to claim 1,
wherein X¹ in the structural unit represented by the formula (1) in the polyester resin is the formula (1A), the formula (1B), the formula (1C) or the formula (1D).

6. The electrophotographic photosensitive member according to claim 1,
wherein the charge transport layer contains a silica particle as a filler particle.

7. A process cartridge that integrally supports an electrophotographic photosensitive member and at least one unit selected from the group consisting of a charging unit, a developing unit and a cleaning unit and that is attached detachably to a main body of an electrophotographic apparatus,
wherein the electrophotographic photosensitive member is an electrophotographic photosensitive member having a support, a charge generation layer formed on the support and a charge transport layer formed on the charge generation layer, the charge transport layer being a surface layer, and
the charge transport layer comprises
a polyester resin having a structural unit represented by the following formula (1) where X¹ represents a divalent group represented by a formula (1A), a formula (1B), a formula (1C), a formula (1D) or a formula (1E), and
a charge-transporting compound represented by the following formula (HTM1);

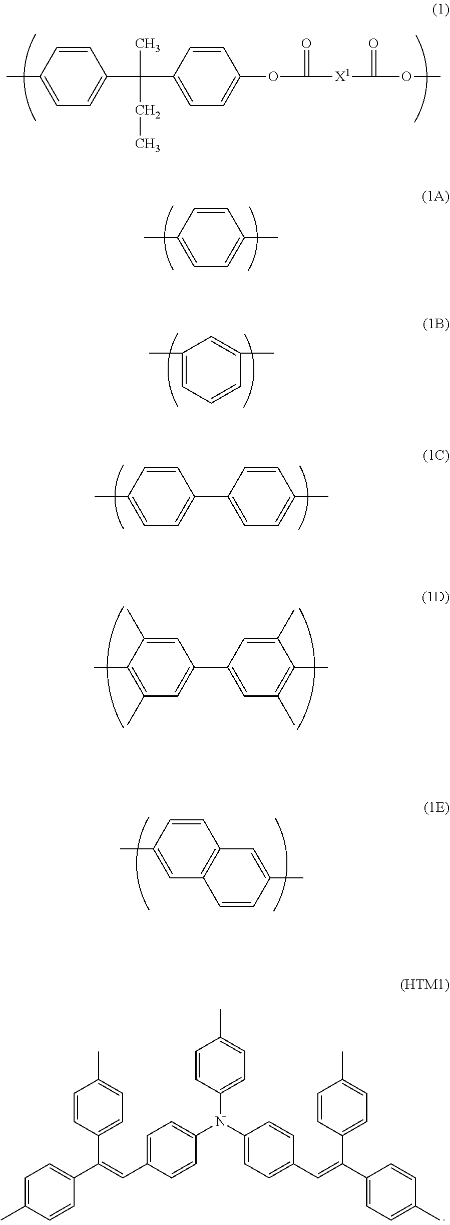

8. An electrophotographic apparatus comprising:
an electrophotographic photosensitive member;
a charging unit;
an exposing unit;
a developing unit; and
a transferring unit,
wherein the electrophotographic photosensitive member is an electrophotographic photosensitive member having a support, a charge generation layer formed on the support and a charge transport layer formed on the charge generation layer, the charge transport layer being a surface layer, and
the charge transport layer comprises
a polyester resin having a structural unit represented by the following formula (1) where X¹ represents a divalent group represented by a formula (1A), a formula (1B), a formula (1C), a formula (1D) or a formula (1E), and
a charge-transporting compound represented by the following formula (HTM1); [chemical structure]
